(19) United States
(12) Patent Application Publication
(10) Pub. No.: US 2013/0195734 A1
(43) Pub. Date: Aug. 1, 2013

(54) REAGENT BOTTLE

(71) Applicant: THERMO SHANDON LIMITED, Cheshire (GB)

(72) Inventors: Eric D. Yeaton, Epsom, NH (US); Christopher J. Nolet, Francestown, NH (US)

(73) Assignee: THERMO SHANDON LIMITED, Cheshire (GB)

(21) Appl. No.: 13/729,964

(22) Filed: Dec. 28, 2012

Related U.S. Application Data
(60) Provisional application No. 61/592,864, filed on Jan. 31, 2012.

(51) Int. Cl. B01L 3/00

(52) U.S. Cl. CPC B01L 3/52
USPC 422/512

(57) ABSTRACT

A reagent bottle includes a reservoir adapted to contain a reagent, a pipette tip defining a fluid channel extending into the reservoir and a resilient seal fixedly disposed within the reservoir and surrounding the pipette tip, the seal functioning to reduce reagent loss when the pipette tip is withdrawn from the reagent bottle. The fluid channel of the pipette tip is defined by the pipette tip being in direct fluid communication, or interrupted fluid communication, with the exterior of the reagent bottle, the pipette tip being directly or indirectly engageable through a fluid-tight fitting with a pipette. A base member of the reagent bottle is adapted for selective engagement with one or more rotation pin and has an indexing feature for properly aligning the reagent bottle within an automated system. The base member adapted for selective engagement with one or more spring pins for raising and lowering the reagent bottle.

### BACKGROUND

1. Field of the Invention

The present invention relates generally to immuno-histochemistry (IHC) staining of tissue samples and more specifically to a reagent bottle with dedicated pipette tip for use within an automated IHC system.

2. Discussion of Background Information

Immuno-histochemistry staining (IHC staining) requires several processing sequences such as, for example, (a) deparaffinization and tissue hydration; (b) target or antigen retrieval, (c) immuno-histochemical staining, (d) counter staining and (e) tissue dehydration. Several instruments have automated the process of IHC staining. In all cases, various instrument resources (e.g., reagents, heat, pipettes, physical locations for slides, wash buffers, etc.) are required for automation. The process of automation requires either (a) the sample (tissue on a slide) to be brought to those resources or (b) resources to be brought to the sample.

The IHC staining step involves using a pipette to transfer a series of reagents from reagent bottles to tissue samples undergoing processing. A single pipette requires washing between consecutive applications of various reagents. Each wash lengthens the duration of the overall process and, therefore, lessens system efficiency. Additionally, using a single pipette with various reagents presents the risk of crossing over reagents between distinct bottles if washing is insufficient.

A need therefore exists for a reagent bottle with dedicated pipette tip that eliminates a need for time consuming pipette washing and eliminates the risk of crossover while enabling efficient, accurate, on demand delivery of reagents within an IHC stainer.

### SUMMARY OF THE INVENTION

One embodiment of the reagent bottle includes a reservoir adapted to contain a reagent, a pipette tip defining a fluid channel extending into the reservoir and a resilient seal fixedly disposed within the reservoir and surrounding the pipette tip, the seal functioning to reduce reagent loss when the pipette tip is withdrawn from the reagent bottle. The fluid channel is defined by the pipette tip being in direct fluid communication, or interrupted fluid communication, with the exterior of the reagent bottle, the pipette tip being directly or indirectly engageable through a fluid-tight fitting with a pipette.

In one embodiment, the reagent bottle includes a base member adapted for selective engagement with one or more rotation pins. In one embodiment, the reagent bottle includes a base member having an indexing feature for properly aligning the reagent bottle within an automated system. In one embodiment, the reagent bottle includes a base member adapted for selective engagement with one or more spring pins for raising and lowering the reagent bottle.

In one embodiment, the reagent bottle further includes a non-removable or tamper-evident fill port element. In one embodiment, the pipette tip is in interrupted fluid communication with the exterior of the reagent bottle, the fluid communication being interrupted by a valve. In one embodiment the valve is a poppet valve.

In one embodiment, the reagent bottle includes a fluid tight fitting between the pipette tip and the reservoir, and in one embodiment, the fluid-tight fitting is a threaded or non-threaded tapered fitting. In one embodiment, the threaded or non-threaded tapered fitting is a 6 degree tapered fitting, and the threaded or non-threaded tapered fitting further comprises a reversibly engageable Luer lock system. In one embodiment, the threaded or non-threaded tapered fitting further comprises a reversibly engageable press fit and trigger release system.

In one embodiment, the pipette tip has a double lugged Luer lock for reversibly engaging with the reservoir and the pipette. In one embodiment, the interior surface of the reservoir terminates in a conical well centered about the longitudinal axis of the fluid channel.

In one embodiment, the reservoir is manufactured from high density polyethylene and the resilient seal is manufactured from Saniprene®.

### BRIEF DESCRIPTION OF THE DRAWINGS

One will better understand these and other features, aspects, and advantages of the present invention following a review of the description, appended claims, and accompanying drawings in which:

FIG. 1 depicts a top perspective view of one embodiment of an automated IHC staining system incorporating reagent bottles according the present invention.

FIG. 2 depicts a front cross section view of one embodiment of the reagent bottle of the present invention.

FIG. 3 depicts an enlarged portion of the cross section view of FIG. 2.

FIG. 4 depicts a front cross section view of one embodiment of a pipette tip portion of the reagent bottle of the present invention engaged with a pipette arm interface head.

FIG. 5 depicts a front view of an alternative embodiment of a pipette tip portion of the reagent bottle of the present invention.

### DETAILED DESCRIPTION

The reagent bottle with dedicated pipette tip solves the problems left unaddressed by standard automated IHC stainers and eliminates time sinks and crossover contamination associated with washing and reusing a single pipette used across all reagents.

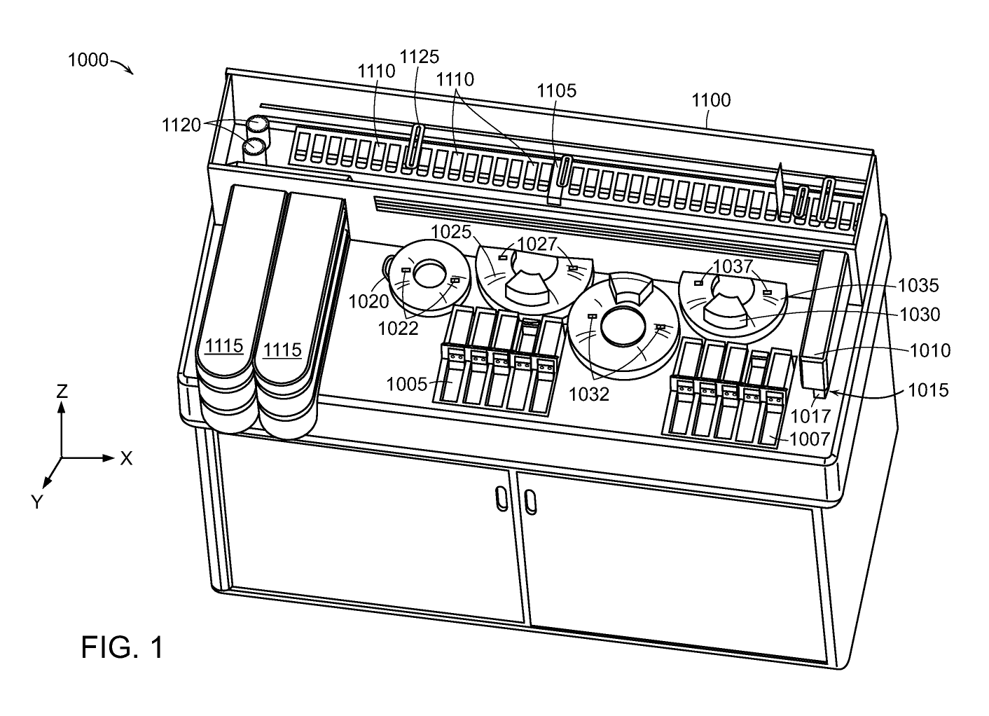

One embodiment of the reagent bottle 10 of the present invention is designed for use within an automated IHC staining system 1000 such as the embodiment shown in FIG. 1. The system of FIG. 1 includes slide input drawers 1005 and slide output drawers 1007 that are the only portion of the machine accessible by an operator. The slide input drawers 1005 and slide output drawers 1007 are designed for receiving identical slide carriers (not shown) with vertical slide arrangement, such as the slide carriers used in the CTM6 coverslipper from Thermo Fisher Scientific. These slide carriers, or baskets, are ubiquitous in the industry and are designed for use in other automated slide handling instruments, such as coverslipping instruments and slide imaging instruments (e.g, Aperio, BioImagene (Ventana/Roche)) to further process the slides following IHC processing. The IHC staining system 1000 may further include an automated coverslipper (not shown) for applying a coverslip over the tissue sample on a processed slide prior to placement in an output slide carrier. The inclusion of an automated coverslipper provides significant workflow and resource benefits and prevents any unintentional damage to slides during required unloading or loading processes.

The IHC staining system 1000 further includes an enclosure (not shown) that sections off the externally exposed slide input drawers 1005 and slide output drawers 1007 and encapsulates a pre-stainer slide handler 1010 (i.e. a robotic arm) that moves in an X-Y plane and operates a gripper 1015 thereon for transporting individual slides 1017 between treatment areas. The IHC staining system 1000 further includes within the enclosed area an oven 1020, a pre-processing carousel 1025, an antigen retrieval carousel 1030 and a post-processing carousel 1035. The gripper 1015 delivers slides 1017 to individual treatment pockets (not shown) positioned at one of two dedicated access ports 1022, 1027, 1032, 1037 within each carousel 1020, 1025, 1030, 1035 so that each slide 1017 receives individualized treatment reagents and/or sequences of processing steps within its dedicated slide pocket.

The IHC staining system 1000 further includes an IHC stainer 1100 into which slides 1017 are fed by an IHC gripper 1105 for treatment with one or more reagents and hema-blue. The IHC gripper 1105 is mated to short support arm (not shown) that pivots on a single axis. The short support arm includes a series of mechanisms that move the IHC gripper 1105 vertically in the Z-axis as well as rotate a slide 1017 from a vertical to a horizontal (X-Y plane) orientation for delivery into one of the ICH processing bays 1110. In the embodiment of FIG. 1, the IHC staining system 1000 includes thirty-six (36) IHC processing bays 1110, each of which is capable of supporting a unique slide treatment protocol (e.g., unique combination of reagents applied to a single slide 1017 under specific incubation temperatures and times). One of ordinary skill in the art will understand that the IHC staining system 1000 may have any number of IHC processing bays 1110 and that the depicted embodiment is intended to be non-limiting. In the embodiment of FIG. 1, an automated refrigerated reagent transport, storage, and retrieval compartment (hereinafter “reagent compartment”) 1115 houses eighty-eight (88) distinct reagent bottles (not shown) for retrieval on demand. Again, one of ordinary skill in the art will understand that the reagent compartment 1115 may house any number of reagent bottles and that the depicted embodiment is intended to be non-limiting. The reagent compartment 1115 automatically retrieves and elevates specifically requested reagent bottles into one of two reagent presentation areas (hereinafter “presentation areas”) 1120 for reagent withdrawal by a pipette 1125 that moves linearly along the length of the IHC stainer 1100. Reagent bottles 100 may be added to and/or removed from the reagent compartment 1115 by an operator while slides 1017 are being processed within the system 1000.

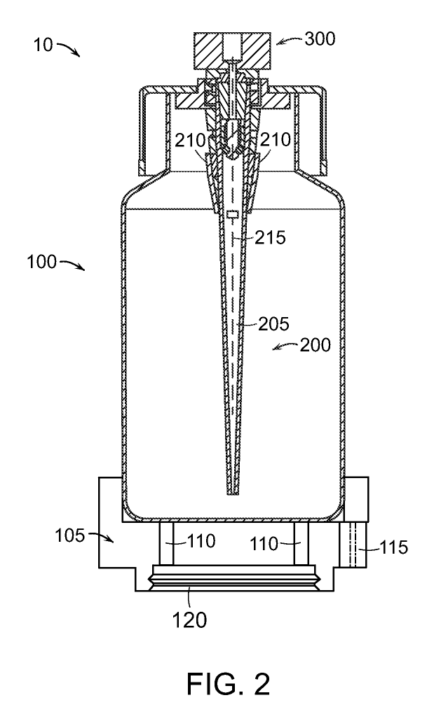

The automated staining system 1000 with moveable pipette 1125 is designed for interactive use with a specially-designed reagent bottle 10. As depicted in FIG. 2, one embodiment of the reagent bottle 10 includes a reservoir 100 adapted to contain a reagent, a pipette tip 200 defining a fluid channel 205 extending into the reservoir 100, and a resilient seal 210 fixedly disposed within the reservoir 100 and surrounding the pipette tip 200. The resilient seal 210 functions to reduce reagent loss when the pipette tip 200 is withdrawn from the reagent bottle 100 as well as squeegee off the outer surface of the pipette tip to eliminate any drips forming on the tip caused by residual surface fluid flowing down the outside of the tip. In one embodiment, the reservoir 100 is manufactured from high density polyethylene, and the resilient seal 210 is manufactured from Saniprene®. One skilled in the art will recognize, however, that these materials are merely design choices, and the reservoir 100 and resilient seal 210 may be manufactured from a variety of other chemically inert materials. For example, the reservoir 100 may be manufactured from materials such as, but not limited to, FEP, Polycarbonate, Polypropylene, or PETE, and the resilient seal 120 may be manufactured from materials such as, but not limited to, TPE (thermoplastic elastomer, Generic acronym that covers many formulations of plastics), silicone, urethane, nitrile, or latex. The fluid channel 205 is defined by the pipette tip 200 being in direct fluid communication, or interrupted fluid communication, with the exterior of the reagent bottle 10, the pipette tip 200 being directly or indirectly engageable through a fluid-tight fitting (i.e. a pipette arm interface head 300) with a pipette 1125. In one embodiment (not shown), the interior surface of the reservoir terminates in a conical well centered about the longitudinal axis 215 of the fluid channel 205 such that all reagent pools directly beneath the pipette tip 200, thereby enabling complete withdrawal of reagent.

In one embodiment, the reagent bottle 10 includes a base member 105 adapted for selective engagement with one or more rotation pins (not shown). The pins extend into a plurality of bores 110 formed through the base member 105. In one embodiment, the base member 105 is adhered to the reservoir 100. In another embodiment, the base member 105 is integrally formed with the reservoir 100 through a process such as, but not limited to, injection molding. In one embodiment, the base member 105 has an indexing feature 115, such as but not limited to a notch, for properly aligning and orienting the reagent bottle 10 within an automated transport mechanism of the reagent compartment 1115 and within the presentation areas 1120. In one embodiment, the base member 105 provides a groove 120 into which one or more spring pins (not shown) securely snap such that the spring pins may raise and lower the reagent bottle 10 into and out of the reagent compartment 1115 and into and out of the presentation areas 1120.

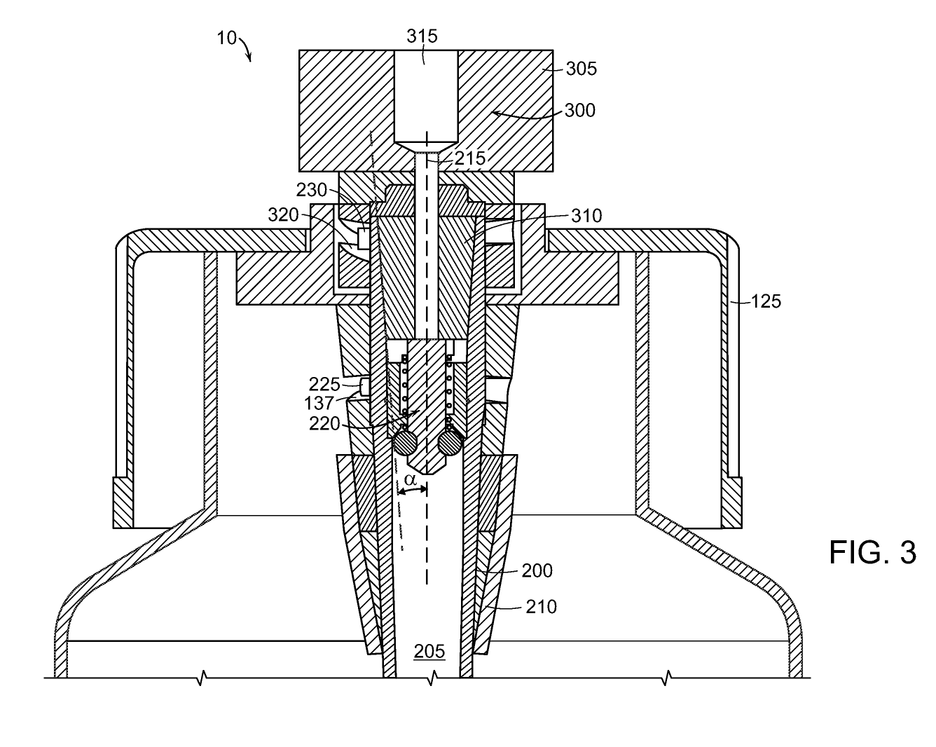

Turning to the enlarged sectional view of FIG. 3, in one embodiment, the reagent bottle 10 further includes a non-removable or tamper-evident fill port element 125, and the pipette tip 200 is selectively removed and reinserted through the non-removable fill port element 125. In one embodiment, the pipette tip 200 is in interrupted fluid communication with the exterior of the reagent bottle, the fluid communication being interrupted selectively by a valve 220, such as but not limited to a spring-actuated poppet valve.

In one embodiment, the reagent bottle 10 includes a fluid tight fitting 135 between the pipette tip 200 and the reservoir 100, and in one embodiment, the fluid-tight fitting 135 is a threaded or non-threaded tapered fitting. In one embodiment, the threaded or non-threaded tapered fitting 135 is a tapered fitting having a taper angle a of six (6) degrees as measured from the longitudinal axis 215 of the pipette tip 200. In one embodiment, the tapered fitting 135 further comprises a reversibly engageable Luer lock system comprised of an angled groove 137 designed to receive a first pipette tip post 225 through rotational engagement. In another embodiment, a non-threaded tapered fitting 135 is designed for use in a reversibly engageable press fit and trigger release system.

In use, the reagent bottle 10 is housed within the refrigerated reagent compartment 1115 (shown in FIG. 1) until the computer-controlled IHC staining system 1000 runs a process requiring a particular reagent housed in a dedicated reagent bottle 10. In one embodiment, each filled reagent bottle 10 is sealed with the non-removable fill port element 125, and the contents therein are retained by the pipette tip 200 and selectively-opened valve 220. Upon request, the reagent bottle 10 is identified by a unique GUID, verified for sufficient remaining reagent volume based on the number of accumulated aspirations already-applied to that GUID-specified reagent bottle 10, elevated through the refrigerated reagent compartment 1115 and delivered to an unoccupied presentation area 1120 for interfacing with the pipette 1125.

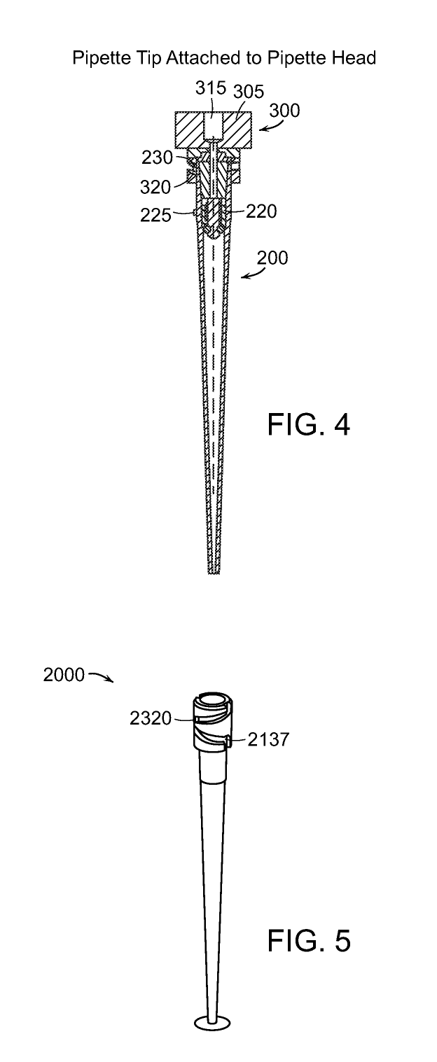

The pipette tip 200 remains in interrupted fluid communication with the exterior of the reagent bottle 10 until the pipette 1125 engages with the pipette tip 200 via a pipette arm interface head 300, as shown in the embodiment of FIGS. 3 and 4. The pipette arm interface head 300 comprises a top member 305 fixedly engaged with the pipette 1125, an integrally formed, tapered protrusion 310, and a longitudinal bore 310 extending therethrough. In the embodiment of FIG. 3, the tapered protrusion 310 mates rotationally with the pipette tip 200, compressing the spring in the poppet valve 220 and putting the fluid channel 205 in open communication with the pipette 1125. The pipette 1125 then may pump reageant (e.g., a fluid, gel, suspension, or emulsion) from the reservoir 100 into the pipette tip 200 in preparation for transfer to a tissue sample on a slide 1017 in the IHC stainer 1100. In the embodiment of FIGS. 3 and 4 the tapered protrusion 310 has an angled groove 320 therein that rotationally engages with a second pipette tip post 230.

The rotational movement requires knowing the orientation of the second pipette tip post 230 relative to the angled groove 320 on the tapered protrusion 310. As indicated in the embodiment of FIG. 2, the automated delivery system incorporated into the refrigerated reagent compartment 1115 delivers each reagent bottle 10 to a presentation area 1120 in a correct orientation based on the location of the indexing feature 115 on the base member 105. The indexing feature 115 may be, for example, a notch into which a post (not shown) inserts for properly aligning the reagent bottle 10 such that a known degree of rotation may be applied for engaging and disengaging the pipette tip 200 from the fluid-tight fitting 135 of the reagent bottle 10 and engaging and disengaging the arm interface head 300 from the pipette tip 200. The elevator (not shown) incorporated into the refrigerated reagent compartment 1115 lifts, spins, and lowers the reagent bottle 10 for rotational engagement and disengagement with the pipette 1125.

Although the embodiment described here with regard to FIGS. 3 and 4 refer to a first pipette post 225 and second pipette post 230 designed for selective rotational engagement with the angled groove 137 of the reagent bottle 10 and the angled groove 320 of the tapered protrusion 310 of the pipette arm interface head 300, other configurations are possible for securely engaging and disengaging the pipette tip 200 with the reagent bottle 10 and pipette 1125. For example, in the embodiment of FIG. 5, the pipette tip 2000 has integrated thereon a plurality of angled Luer lock grooves 2137 and 2320 for rotationally engaging and disengaging protrusions (not show) respectively disposed on the tapered fitting 135 of the reagent bottle 10 and the pipette arm interface head 300 of the pipette 1125. In other embodiments, the pipette tip 200 may engage with the pipette 1125 though another secure fitting such as, but not limited to, a press fit engagement, a face seal, an automated clamp, or the like.

Returning now to the system overview of FIG. 1 and with reference to the elements of the embodiment of FIG. 2, once filled by the engaged pipette 1125, the pipette tip 200 is withdrawn from the reagent bottle 10 and the resilient seal 210 wipes excess reagent from the outside surface of the pipette tip 200, thereby preventing loss of reagent and lowering cycle cost and increasing accuracy of dispense. The IHC staining system 1000 then directs the automated pipette 1125 to deliver the engaged, filled pipette tip 200 to a specific IHC processing bay 1110 for treatment of a slide 1017 therein. Following delivery of the reagent to a tissue sample on a recipient slide 1017, the pipette 1125 returns the pipette tip 200 to its dedicated reagent bottle 10. No washing is required for the pipette tip 200 because the pipette tip 200 resides only in one reagent bottle 10 for use with the unique reagent contained therein. This eliminates the risk of mixing reagents between bottles and this eliminates approximately 15 seconds per cycle of reagent retrieval and application.

The IHC stainer 1100 is the rate limiting step in the IHC staining system 1000. An IHC staining process comprises the steps of, for example, delivering reagent onto tissue on a slide 1017, incubating reagent on the tissue, and washing reagent from the tissue (e.g. with an air knife). These steps occur with, on average, 7 or 8 different reagents for each tissue sample in the IHC stainer 1100. In the embodiment of FIG. 1, that equates to 7 or 8 reagent drops over 32 slides, thereby making the pipette 1125 delivering reagent the key limiting factor in efficiency. If the system 1000 required washing a pipette tip 200 for 15 seconds within each duty cycle, that would cut throughput in half If efficiency is defined by throughput in slides processed per hour divided by cost, then a duty cycle for the pipette 1125 and reagent bottle 10 configuration of the present invention increases efficiency because no washing is required for the pipette tip 200. Simulations of the embodiment of the IHC staining system 1000 of FIG. 1 indicate that the pipette 1125 would run at 98-99% efficiency over a 15 second duty cycle using the described automated pipette 1125 and reagent bottle 10 combination.

In addition to the features of embodiments of the reagent bottle 10 described herein, additional optional features enable agitation of reagent prior to aspiration by the pipette 1125. For example, in one embodiment, the reagent bottle 10 may include fins (not shown) integrally formed with the interior walls of the reservoir 100. The fins, like washing machine fins, cause turbulent vortices in the reagent when the refrigerated reagent compartment 1115 lifts and spins the reagent bottle 10. In one such embodiment, the IHC staining system 1000 may run a protocol specifically for agitating contents the reagent bottle 10 by rotating the reagent bottle 10 back and forth. In another embodiment, the reservoir 100 of the reagent bottle 10 may further include therein mixing marbles (not shown) like those of a spray paint can that agitate the reagent upon movement of the reagent bottle 10 by the refrigerated reagent compartment 1115. In another embodiment, the reservoir 100 of the reagent bottle 10 may further include magnets (not shown) that spin in the presence of magnetic flux such that the reagent is agitated by the rotating magnets. In another embodiment, the IHC staining system 1000 may run a protocol specifically for aspirating contents the reagent bottle 10 into the pipette tip 200 and dispensing the reagent back into the reservoir 100, thereby agitating the reagent within the reservoir.

It is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

We claim:

1. A reagent bottle comprising:
a) a reservoir adapted to contain a reagent;
b) a pipette tip defining a fluid channel extending into the reservoir, the fluid channel defined by the pipette tip being in direct fluid communication, or interrupted fluid communication, with the exterior of the reagent bottle, the pipette tip being directly or indirectly engageable through a fluid-tight fitting with a pipette; and
c) a resilient seal fixedly disposed within the reservoir and surrounding the pipette tip, the seal functioning to reduce reagent loss when the pipette tip is withdrawn from the reagent bottle.

2. The reagent bottle of claim 1, further comprising a base member adapted for selective engagement with one or more rotation pins.

3. The reagent bottle of claim 1, further comprising a base member having an indexing feature for properly aligning the reagent bottle within an automated system.

4. The reagent bottle of claim 1, further comprising a base member adapted for selective engagement with one or more spring pins for raising and lowering the reagent bottle.

5. The reagent bottle of claim 1, further comprising a non-removable or tamper-evident fill port element.

6. The reagent bottle of claim 1 wherein the pipette tip is in interrupted fluid communication with the exterior of the reagent bottle, the fluid communication being interrupted by a valve.

7. The reagent bottle of claim 6 wherein the valve is a poppet valve.

8. The reagent bottle of claim 1, further comprising a fluid tight fitting between the pipette tip and the reservoir.

9. The reagent bottle of claim 8 wherein the fluid-tight fitting is a threaded or non-threaded tapered fitting.

10. The reagent bottle of claim 9 wherein the threaded or non-threaded tapered fitting is a 6 degree tapered fitting.

11. The reagent bottle of claim 9 wherein the threaded or non-threaded tapered fitting further comprises a reversibly engageable Luer lock system.

12. The reagent bottle of claim 9 wherein the threaded or non-threaded tapered fitting further comprises a reversibly engageable press fit and trigger release system.

13. The reagent bottle of claim 1 wherein the pipette tip further comprises a double lugged Luer lock for reversibly engaging with the reservoir and the pipette.

14. The reagent bottle of claim 1 wherein the interior surface of the reservoir terminates in a conical well centered about the longitudinal axis of the fluid channel.

15. The reagent bottle of claim 1 wherein the reservoir is manufactured from high density polyethylene.

16. The reagent bottle of claim 1 wherein the resilient seal is manufactured from Saniprene®.
